(19) United States
(12) Patent Application Publication
(10) Pub. No.: US 2011/0072944 A1
(43) Pub. Date: Mar. 31, 2011

(54) FLEXIBLE LINKED CUTTING SYSTEM

(76) Inventor: Jeffrey Eggers, Newport Beach, CA (US)

(21) Appl. No.: 12/569,703

(22) Filed: Sep. 29, 2009

(51) Int. Cl. B26D 1/50; B26D 7/08; B26D 7/26

(52) U.S. Cl. 83/168; 83/831; 83/698.11; 83/169

(57) ABSTRACT

A flexible cutting apparatus can have an alternating arrangement of different links including a cutting link forming a strand or band. The cutting link can be used to cut material with a cutting tool. A connecting link can be used to connect the cutting links. The cutting link can include a link with a cutter that is either part of the link or attached to the link.

### BACKGROUND OF THE INVENTION

1. Field of the Invention

The present invention relates generally to saws, blades and other cutting tools. In particular the present invention relates to flexible linked cutting systems.

2. Description of the Related Art

Flexible cutting apparatus can be used in various types of cutting tools, including band saws, chain saw, wire saws, and cable saws. Flexible cutting apparatus can be described as blades, wires, chains, cables, etc. Each of these may include teeth, or other hard surfaces designed to cut. Cutting can include rough or fine cuts, sawing, scraping, honing, abrading, shaving, grinding, etc. Many cutting and abrading applications have benefited from these various available flexible cutting apparatus.

As an example of a flexible cutting apparatus, cable saws generally use a continuous cable with cutting or abrading beads. The beads may be strung onto or directly attached to the cable. Where the beads are strung onto the cable there may also be spacers in-between the cutting beads.

The thickness of the wire used often depends on the application or the object to be cut. As the thickness and strength of the wire increase, so does the stiffness. For example, a cable saw used for mining operations is likely to use a wire or braided cable thicker than the wire used to cut glass or to cut a silicone wafer.

### SUMMARY OF THE INVENTION

There exists a continuing need to develop stronger and more flexible cutting apparatus. Along with this need, there also exists a need to develop new designs for cutting tools to facilitate the use of the new flexible cutting apparatus.

Embodiments disclosed herein include a cutting system that can comprise a plurality of first links, a plurality of second links, and a plurality of cutting beads. The each of the plurality of first links can include a first end, a second end, and a central portion connecting the first end and the second end. Each of the plurality of second links can include an external surface, and an internal surface. At least one of the first end and the second end of one of the plurality of first links can form a joint with the internal surface of each of the second links. Also, each cutting bead can be connected to the external surface of one of the plurality of second links.

The cutting system can comprise an alternating configuration of one of the plurality of first links and one of the plurality of second links, wherein each of the plurality of second links and the connected cutting beads are configured to freely rotate independent of the position of the other links. The cutting system can further include ball and socket joints and/or be self-lubricating. In some embodiments, each of the plurality of second links comprises two connecting portions that define the external surface and the internal surface.

In certain embodiments, a cutting system can comprise a plurality of first links, a plurality of second links, and a plurality of cutting beads. Each first link can have ball ends and a shaft connecting the ball ends. Each second link can have a first end inside surface configured to form a ball and socket joint with one of the ball ends of one of the plurality of first links and a second end inside surface configured to form a ball and socket joint with one of the ball ends of another one of the plurality of first links. Each cutting bead can be configured to connect to an outside surface of one of the plurality of second links.

The second links may further comprise first and second portions that when connected form a chamber inside the second link and define the inside surfaces of the first end and the second end. It can also include an interlocking feature to interlock the portions, and/or a restraining feature to prevent separation of the cutting bead from the outside surface of the second link.

The cutting system can further comprise lubricant within the chamber in each of the plurality of second links. In use, the internal chamber of each of the plurality second links can be substantially sealed so that the cutting system is self-lubricating.

In some embodiments, a cutting system can comprise a fluid channel and a vacuum conduit. The cutting system can be configured to direct fluid through the fluid channel at a plurality of first and second links and cutting beads, to thereby clean off and remove debris from a cutting action of the plurality of cutting beads. The vacuum conduit can be positioned and configured to remove the fluid and the debris. The system can further comprise a cog for engaging the plurality of first and second links and cutting beads. The cog can have internal piping to direct the fluid at areas of the plurality of first and second links and cutting beads engaged with the cog.

Embodiment of a cutting device can comprise a plurality of main bodies linkedly connected in series along an axis and a plurality of generally cylindrical cutting surfaces. The cutting surface can be configured to surround a portion of one of the plurality of main bodies. The cutting device can be configured to support a tension along a length of the cutting device. The plurality of cutting surfaces can be configured to independently rotate about their respective axes.

### BRIEF DESCRIPTION OF THE DRAWINGS

In order to better understand the invention and to see how it may be carried out in practice, some preferred embodiments are next described, by way of non-limiting examples only, with reference to the accompanying drawings, in which like reference characters denote corresponding features consistently throughout similar embodiments in the attached drawings. Where a prime symbol (′) has been added to the numerical reference, it is to be understood that the components are the same or substantially similar to previously-described components.

FIG. 1 illustrates a segment of a flexible cutting apparatus.

FIG. 2A shows a perspective view of a first link.

FIG. 2B shows a side view of another embodiment of a first link.

FIG. 3 is a perspective view of a second link.

FIG. 3A is a perspective view of a portion of the second link of FIG. 3.

FIG. 3B is a right side view of the portion of FIG. 3A.

FIG. 3C is a top view of the portion of FIG. 3A.

FIG. 3D is a left side view of the portion of FIG. 3A.

FIG. 4 illustrates a segment of an embodiment of a flexible cutting apparatus.

FIGS. 5A-B show perspective views of a cutting bead.

FIG. 5C is a cross-section of the cutting bead of FIGS. 5A-B.

FIG. 6 illustrates two first links connected to an assembled cutting bead and second link with the cutting bead and second link in cross-section.

FIG. 7 shows a segment of a flexible cutting apparatus in various stages of assembly.

FIG. 8 is an embodiment of a partially disassembled cutting tool.

FIG. 9 is a detail view of the cutting tool of FIG. 8.

### DETAILED DESCRIPTION OF THE PREFERRED EMBODIMENT

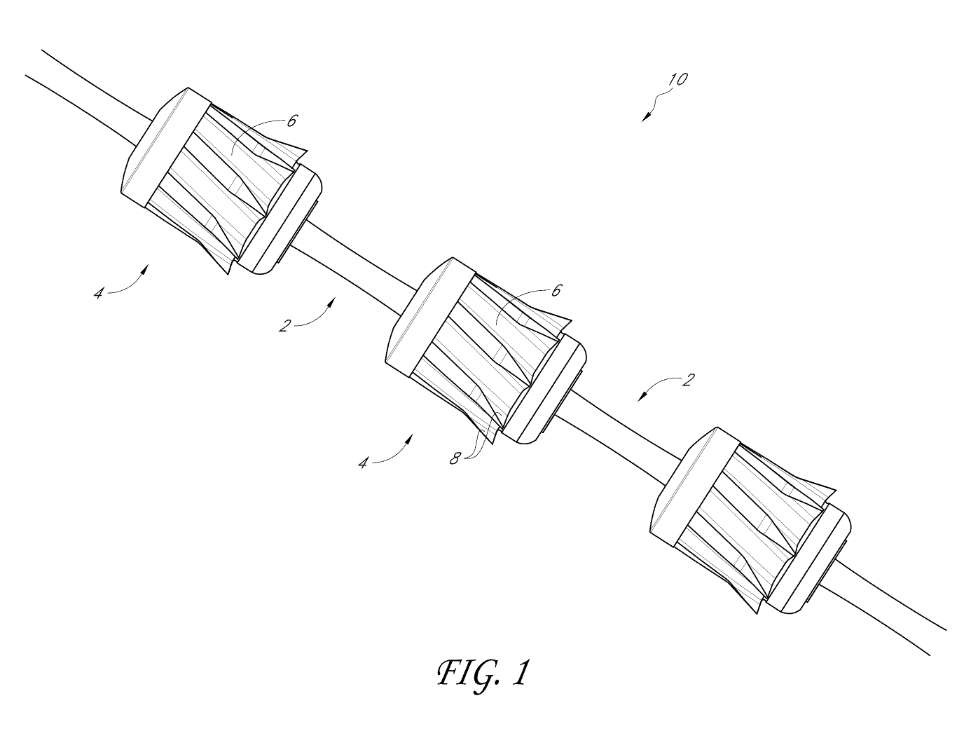

A flexible cutting apparatus can be used in a cutting tool for many different applications. Shown in FIG. 1 is part of a flexible cutting apparatus 10 that can be used in various cutting tools and for various applications. For example, the flexible cutting apparatus 10 can be used in a cable saw, a chain saw, a band saw, etc. In addition, the flexible cutting apparatus 10 can be used to cut different materials, including: wood, metal, concrete, stone, bone, and plant material.

FIG. 1 illustrates a portion of a flexible cutting apparatus 10 having an alternating arrangement of two different types of links 2, 4. A series of first links 2 are alternated with a series of second links 4. The first link 2 can be a connecting link and the second link 4 can be a cutting link. The connecting link 2 can be used to connect a series of cutting links 4 together in a type of chain that makes up the flexible cutting apparatus 10. The flexible cutting apparatus 10 can be a strand with two ends, or those ends can be connected to form a band or loop.

In some embodiments, two or more different types of links can be used. The arrangement of links can be an ordered pattern and/or a random configuration. In some embodiments, only one type of link is used. The link can both connect to other links and can be used to cut material.

As will be described in more detail below, the second link 4 can include a cutter 6 which may comprise at least one of a blade, a cutting bead, a hard surface, a tooth, etc. In some embodiments such as the one illustrated, the cutter 6 can comprise a cutting bead with a plurality of cutting teeth 8 that surround the second link 4.

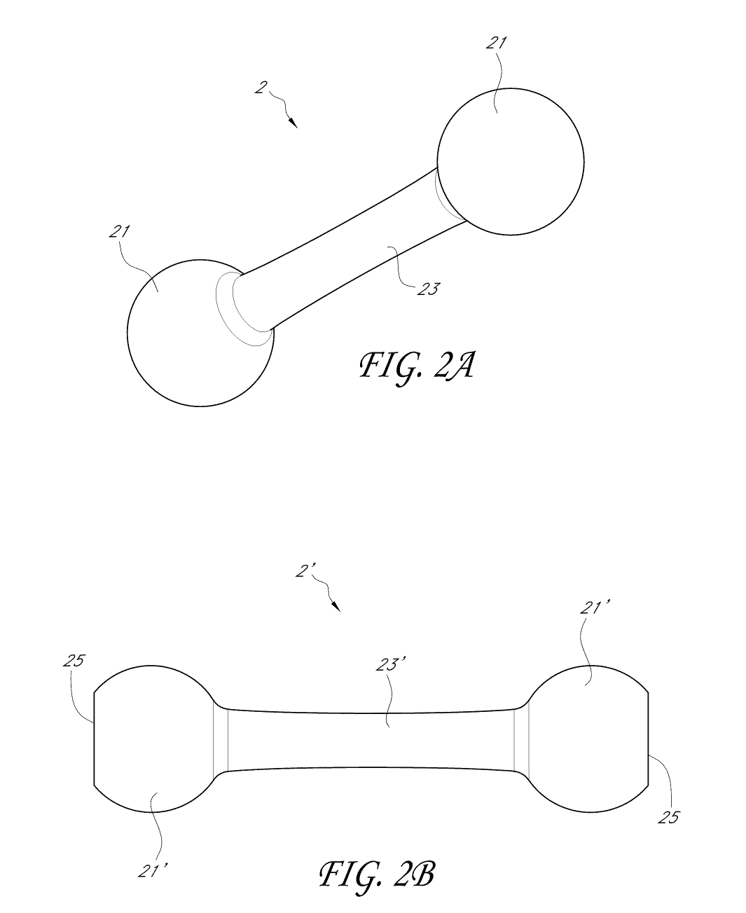

Turning now to FIG. 2A, one embodiment of a first link 2 is shown. The first link 2 can be a connecting link and configured to connect other links together. The first link 2 has two ends 21. The ends 21 can be configured, shaped and/or contoured to connect to other links. The ends 21 shown are ball shaped and can be used to form ball and socket joints with other links.

Also shown is a central portion or shaft 23. The central portion 23 can connect the two ends 21. The size and shape of the central portion 23 can depend on various factors. For example, the desired clearance between where the different links connect, the desired length between cutters, and the desired length of the flexible cutting apparatus 10 can all be factors used to determine the shape and size of the connecting region 23. Another consideration can be the desired minimum diameter for the flexible cutting apparatus 10 around a cog or gear. So for example, to increase the flexibility of the flexible cutting apparatus 10, the outer dimensions of the central portion 23, here the outer diameter, can be less than the outer dimensions of the ends 21. This can allow the other link, connected to the end 21, to have a large range of motion about the connection point or joint.

One or more of the ends 21 can be shapes other than balls to form a connection point or joint similar to or different from a ball and socket joint. For example, one or more of the ends 21 can be round, semispherical, spherical, elliptical, oval, conical, triangular or pyramidal. The ends 21 can be keyed or shaped to form part of a hinge or other moveable joint. As shown in FIG. 2B the ends 21′ of the first link 2′ are ball shaped with flat ends 25. An advantage to the above shape is the ability to decrease material costs without losing the functionality of the remaining ball surface. Other shapes can also be used and other types of joints can be formed.

The first link 2 can be manufactured according to many different methods. In a preferred embodiment the first link 2 is cast, but it can also be extruded, stamped, milled, etc. The first link 2 can be made from titanium, high grade steel, steel, various alloys, high strength polymer, carbon fiber, etc. In some embodiments, the first link 2 comprises a central portion 23 formed of cable or wire, such as a multi-strand steel cable. The ends 21 can be steel balls, or other shapes and materials, that are clamped, crimped or otherwise secured to the central portion 23 whether by mechanical devices or adhesive/epoxy. In still other embodiments, the cable or wire is formed to provide ends 21 that can be used to attach the first link 2 to other links without adding additional material. The central portion 23 can be flexible or rigid.

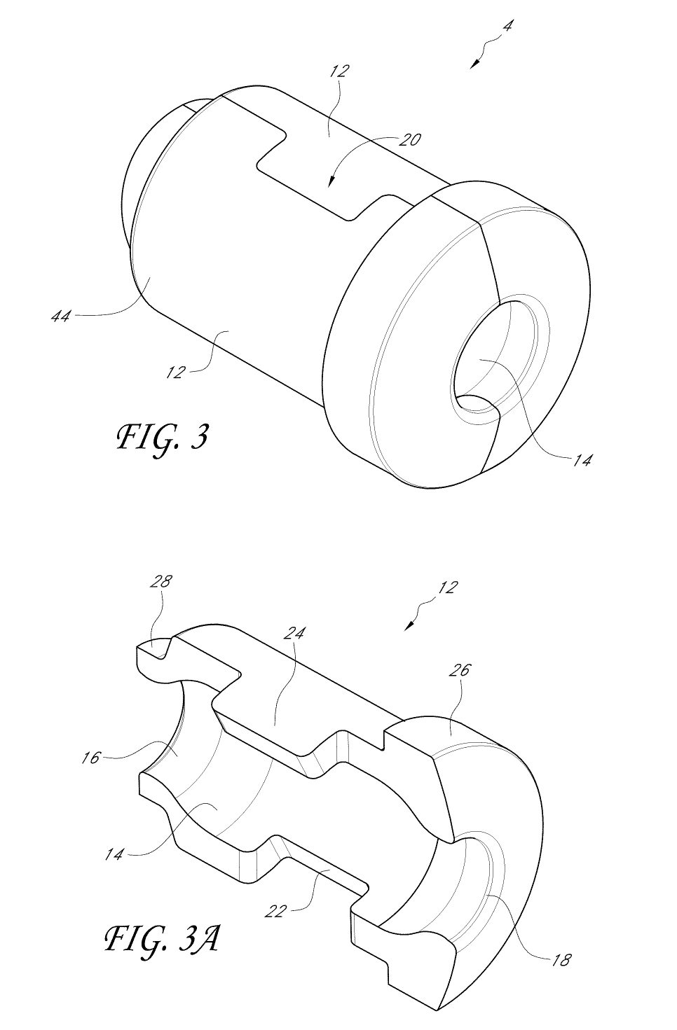

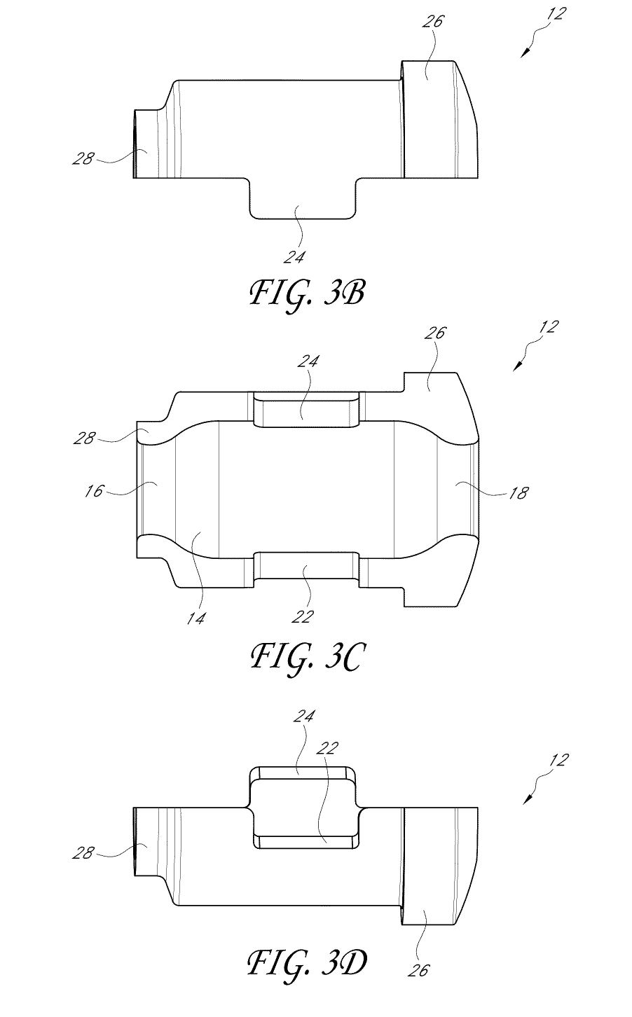

FIG. 3 shows an embodiment of a second link 4. The second link 4 shown is made of two portions 12. The two portions 12 can connect together to form the second link 4. The second link 4 can have an internal chamber 14. The internal chamber 14 can be used to connect the second link 4 to one or more first links 2 as will be described in more detail below.

FIGS. 3A-D show a portion 12 of an embodiment of a second link 4. As shown, the second link 4 can comprise two portions 12. In some embodiments, the two portions 12 are mirror images of one another. In some embodiments, the two portions 12 are identical pieces, such as one ones illustrated here, while in others the portions 12 are not identical. In some embodiments, the second link 4 can comprise one, two, three or more portions.

The portion 12 can form all or part of the internal chamber 14 of the second link 4. The portion 12 can form all or part of a first hole 16 and a second hole 18. The first and second holes 16, 18 can be configured to accommodate the central portion 23 of the first link 2. The particular dimensions, or in this case diameter, of the holes 16, 18 can be chosen based on many different factors, such as the shapes and sizes of the end 21 and central portion 23 of the first link 2, the amount of desired clearance or rotation allowed between the links when connected, the stress loads expected to be experienced at the joint or connection, etc. In a preferred embodiment, the dimensions of the holes 16, 18 are less than the largest outer dimension of the end 21 of the first link and greater than the largest dimension of the central portion 23 immediately adjacent to the end 21.

According to certain embodiments, the second link 4 can have an interlocking feature 20 (FIG. 3) between the different portions 12, or between a portion 12 and a cap or some other connecting piece. The interlocking feature 20 can be configured to connect, align, or otherwise position the portion 12 with the corresponding portion 12, cap, or other connecting piece.

In some embodiments, the interlocking feature 20 can include a protrusion 24 and a groove 22. The protrusion 24 can be configured to fit in the groove 22. In some embodiments, the protrusion 24 and groove 22 form a friction fit to secure two portions 12 together. In some embodiments, an adhesive or epoxy is used to secure the portions 12 together, independent of whether the second link 4 includes an interlocking feature 20, and independent of whether the interlocking feature 20 forms a tight or loose connection. In some embodiments, the portions 12 are welded together. For example, a spot weld can be made anywhere along a connecting seam between the connected portions 12.

The second link 4 may further include a sleeve (not shown). The sleeve can secure the two or more portions together. In some embodiments, the sleeve comprises an epoxy which welds or secures the portions 12 together.

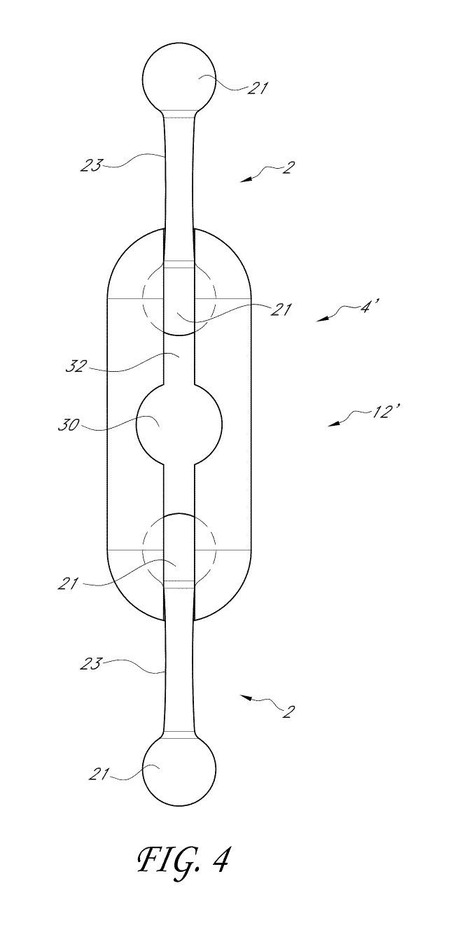

Referring now to FIG. 4, an alternative embodiment is shown wherein the second link 4′ comprises only one portion 12′. The one portion 12′ can have a hole 30 in the middle large enough for an end 21 of a first link 2 to enter into the second link 4′. The portion 12′ can also have a slot 32 on either side of the hole 30. The slot 32 can be shaped and sized so as to allow a first link 2 to slide through the slot into position on either end of the second link 4′ as shown. The second link 4′ can further comprise a cap to cover the hole 30 and/or the slot 32.

As mentioned above, the second link 4 can include a cutter 6. The cutter 6 can be part of the second link 4 or can be a separate piece. For example, in some embodiments, the cutter 6 can comprise part of the first link 2, the second link 4 or a different link (not shown). In some embodiments, the cutter 6 can be part of one or more portions 12 of the second link 4. The cutter 6 can comprise at least one of a blade, a cutting bead, a hard surface, a tooth, etc.

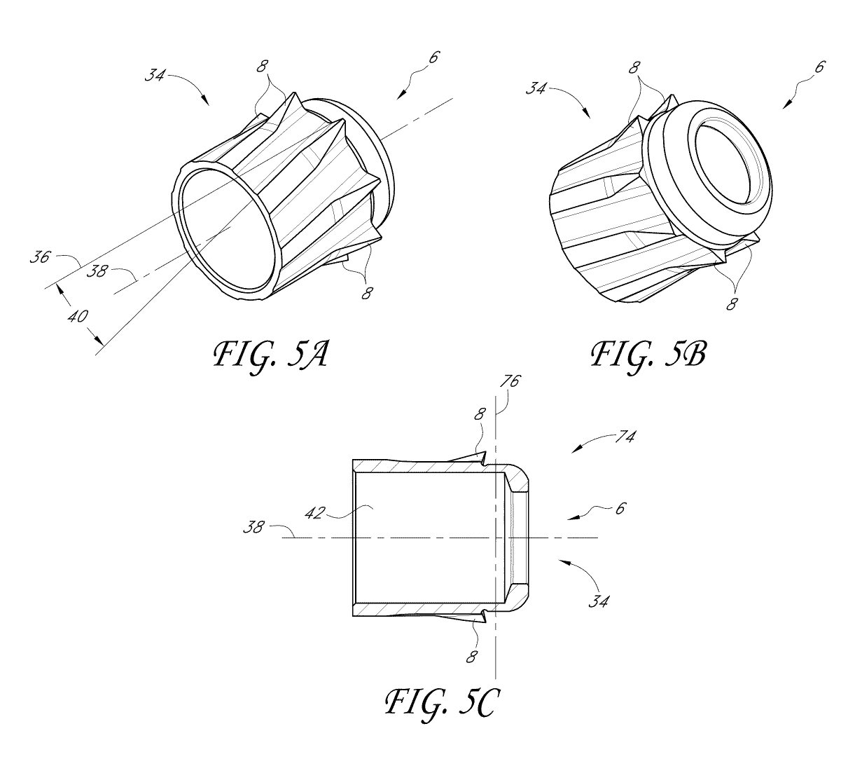

Looking to FIGS. 5A and B, one embodiment of a cutter 6 is shown wherein the cutter 6 comprises a cutting bead 34 with a plurality of cutting teeth 8. The cutting bead 34 can be attached to the second link 4 and can be used to cut other materials. The cutting bead 34 can be one of many shapes. For example, the cutting bead 34 can have a rounded end as shown, or be more cylindrical, conical, square, etc.

The plurality of cutting teeth 8 can surround the cutter 6 as shown, but can also be in specific regions or areas of the cutter 6. For example, some embodiments have only one cutting tooth 8, or one or more cutting teeth 8 on one or more sides of the cutting bead 34. The cutting teeth 8 can also be angled. FIG. 5A shows how the cutting teeth 8 can be offset an angle 40 from a line 36 that is parallel with a central axis 38 of the cutting bead 34.

In some embodiments, the angle 40 can be between 1 and 45 degrees. In some embodiments, the angle 40 can be between 2 and 12 degrees or between 2 and 3 degrees. The angle 40 can depend on many features such as the material to be cut and the amount of friction desired to rotate the cutter 6.

FIG. 5C shows a cross section of the cutting bead 34. The cutting bead 34 can be a sleeve or cap contoured to fit over the second link 4. For example, in some embodiments, the cutting bead 34 is sized to connect to the second link 4 with a press fit. In this and in other embodiments, the cutter 6 can be connected to the second link 4 with adhesive. In a preferred embodiment, the interior surface 42 is contoured to substantially fit on the outer surface 44 (FIG. 3) of the second link 4.

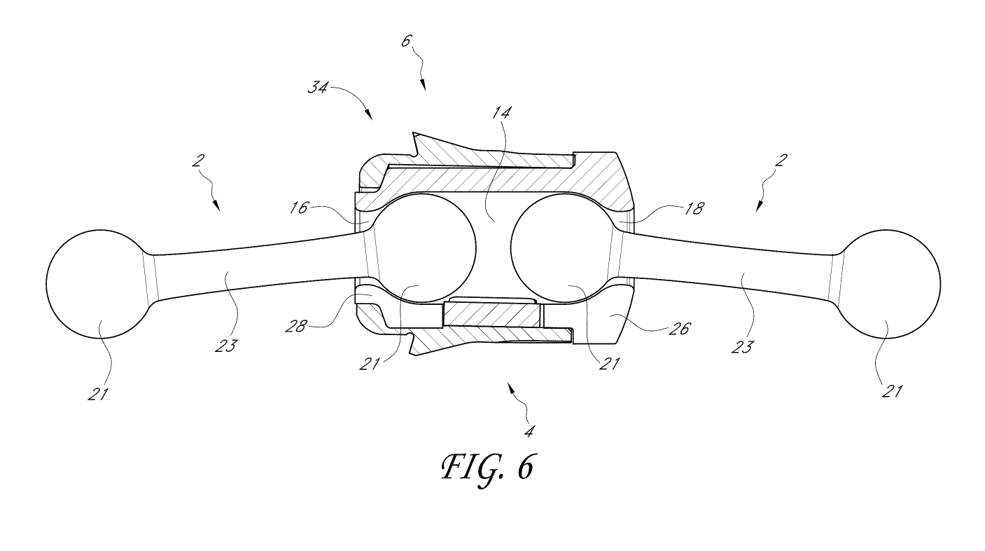

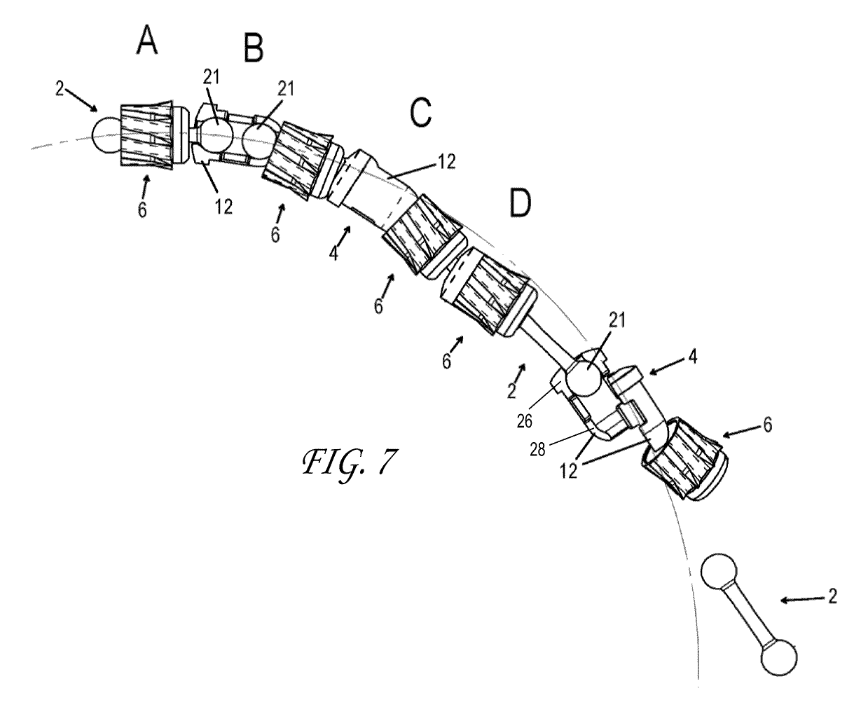

The assembly of one embodiment of a flexible cutting apparatus 10 will now be explained. FIGS. 6 and 7 show portions of a flexible cutting apparatus 10 in various stages of assembly and in various cross sections. FIG. 6 shows two first links 2 and the cross section of the assembled second link 4 and cutter 6, where the cutter 6 is a cutting bead 34. It can been seen that the ends 21 of the first link 2 are in the internal chamber 14 of the second link 4, which creates two ball and socket joints connecting the first and second links 2, 4. The ball and socket joints can allow the links to rotate with respect to one another and independent of each other. It can also be seen that the cutting bead 34 surrounds a large portion of the second link 4.

The cutting bead 34 can rotate with the second link 4. The teeth on the cutting bead 34 can be configured and shaped to rotate the cutting bead about its axis while cutting. For example, the teeth can be angled as discussed previously, which can cause the cutting bead 34 to rotate as it cuts through a piece of material.

Rotating cutters can provide many benefits. For example, the rotation can allow multiple teeth on each cutter 6 to participate in the cut allowing the cutter to provide a smoother and cleaner cut. The rotation can also help prevent the cutting tooth from breaking if a different or difficult to cut material is encountered. For example, a cutting tool used to cut plant material that does not rotate may be broken off or damaged if a rock is encountered. A cutting tool using a flexible cutting apparatus that rotates can avoid forcing the cutting tooth directly into the rock both because of the flexibility and the rotation of the apparatus, thereby reducing the likelihood of breakage or damage.

The flexible cutting apparatus 10 can be internally lubricated. In some embodiments, the method of assembly can include a step of injecting or inserting a lubricant into the internal chamber 14 of the second link 4. In some embodiments, silicone with a lubricant or another material can be injected or inserted into the internal chamber 14. The silicone or other material can also help to maintain the position of the ends 21 within the second link 4. For example, silicone can help keep the ends 21 from contacting one another.

The internal chamber 14 can be ceramic coated or have another or additional coating. The coating can assist with or can provide lubrication. The ends 21 of the first link can also be coated with a ceramic and/or other coating.

The internal chamber 14 can be essentially sealed. The ends 21 can seal the holes 16, 18 in the second link 4.

With a sealed internal chamber 14 and lubricant inside the internal chamber 14, the flexible cutting apparatus 10 can be self lubricating. This can be very advantageous as certain currently available flexible cutting apparatus 10 such as typical used in chainsaws require continual and constant re-lubrication. Chainsaws typically have a reservoir that continually lubricates the chain. A self lubricating flexible cutting apparatus 10 may not require continual re-lubrication or a reservoir for that purpose, though one can be provided for certain applications.

In some embodiments, the second link 4 can include a port for inserting or injecting a lubricant or other material before or after the portions 12 have been connected and sealed.

FIG. 7 shows the steps of an example method for assembling a flexible cutting apparatus 10. The steps can correspond to the different segments A-D shown in FIG. 7. In step A, a first link 2 can be placed inside a cutter 6. In step B, opposite ends of two first links 2 can be placed inside a first portion 12 of a second link 4. Then in step C, a second portion 12 can be connected to the first portion 12. Last, in step D, the cutter 6 can be slid over the second link 4. These steps, or variations thereof, can be repeated to connect multiple first and second links 2, 4.

As shown, the second link 4 has a flange 26 at one end. The cutter 6 can be slid over the second link 4 until an end of the cutter 6 abuts the flange 26. This can provide the proper contact between the second link 4 and the cutter 6. In addition, a configuration of this type can help the cutter 6 to maintain the proper connection with the second link 4 while the apparatus is in use. Advantageously, the rotation of the flexible cutting apparatus 10 can be such as to force the end of the cutter 6 against the flange 26, instead of forcing them apart. This can help the cutter 6 to maintain its connection with the second link 4.

The cutter 6 can also be shaped to correspond to a portion of the outer surface 44 of the second link 4 (FIG. 3). For example, in FIG. 7, the cutter is shown sliding over a rounded end of the second link. The end 28 of the second link can also be flat or stepped down in diameter. The internal surface 42 of the cutter 6 (FIG. 5C) can be contoured to fit the outer surface 44 of the second link 4 (FIG. 3). For example, FIGS. 5C and 6 show how the internal surface 44 of the cutter 6 can match a stepped down outer surface 42 of the second link 4. This configuration can also be used to help ensure that the cutter 6 and second link 4 are maintained in properly connected positions.

In other embodiments, other links can also be connected to either of the first or second link 2, 4. Depending on the application and the design of the cutter 6, careful attention should be paid to the orientation of the cutter 6. For example, as shown in FIG. 7, the cutter 6 is a cutting bead configured to cut in one direction and it can be desirable that each cutting bead be orientated in the same direction. Other configurations are also possible.

In certain embodiments, the method can further include attaching the various components with an adhesive. For example, the portions 12 can connect together with the assistance of an adhesive, the second link 4 and the cutter 6 can connect with adhesive, etc. These connections can also be press or friction fits.

Various other embodiments and variations of the above are also envisioned. For example, in certain embodiments, a chain comprises a first link 2 and a second link 4 without a cutter 6. In other embodiments, the second link 4 and the cutter 6, such as a cutting bead 34, are attached to a continuous or segmented cable or wire. The second link can clamp onto the wire and the cutter 6 can secure the second link 4 in place on the wire.

In some embodiments, the cutter 6 can rotate on the flexible cutting apparatus 10. In some embodiments, the cutter 6 can fit over the second link 4 but does not form a friction or press fit; rather, the cutter 6 can rotate over the second link 4. Referring to FIG. 5C, the cutting bead 34 can be divided into two pieces. The stepped down diameter section 74 on the right of the figure can be separated from the rest of the cutting bead 34 at line 76. The end 74 can be used as a cap which is secured to the second link 4 while the cutting bead 34 is configured to freely rotate around the second link 4.

In some embodiments, one or more ball bearings can be used to allow the cutter 6 to rotate. For example, referring back to FIG. 4, a ball bearing can be inserted into the hole 30 shown in FIG. 4. A cutter 6, such as the cutting bead 34 shown in FIGS. 5A-C, can be place on or over the second link 4′ and can rotate with respect to the second link 4′ with the assistance of the ball bearing.

Structures consistent with the teachings contained herein, when driven by appropriate drive and guide mechanisms, can be used to cut a wide variety of materials, in a wide variety of configurations. In a preferred embodiment, the flexible cutting apparatus 10 is used in a cutting tool to trim plant material such as trimming leaves of palm trees. In another preferred embodiment, the cutting tool is a surgical cutter used to cut bone.

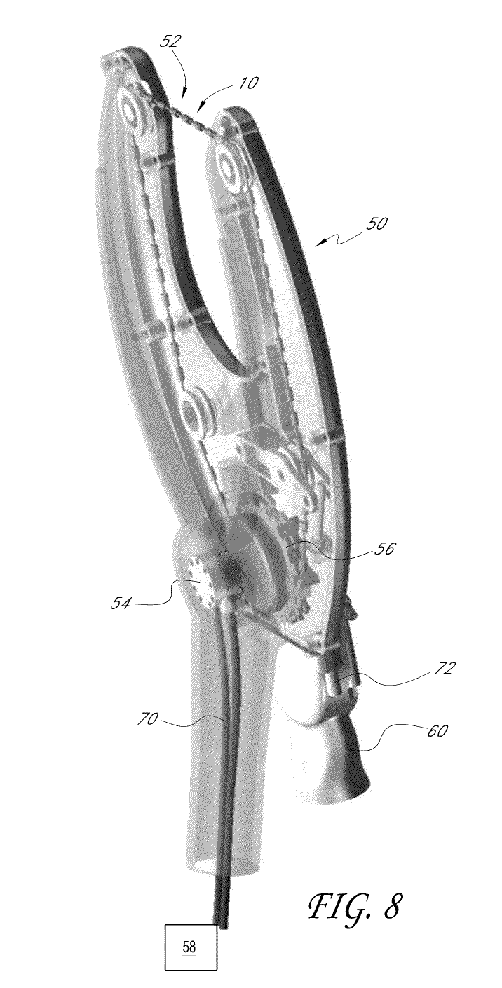

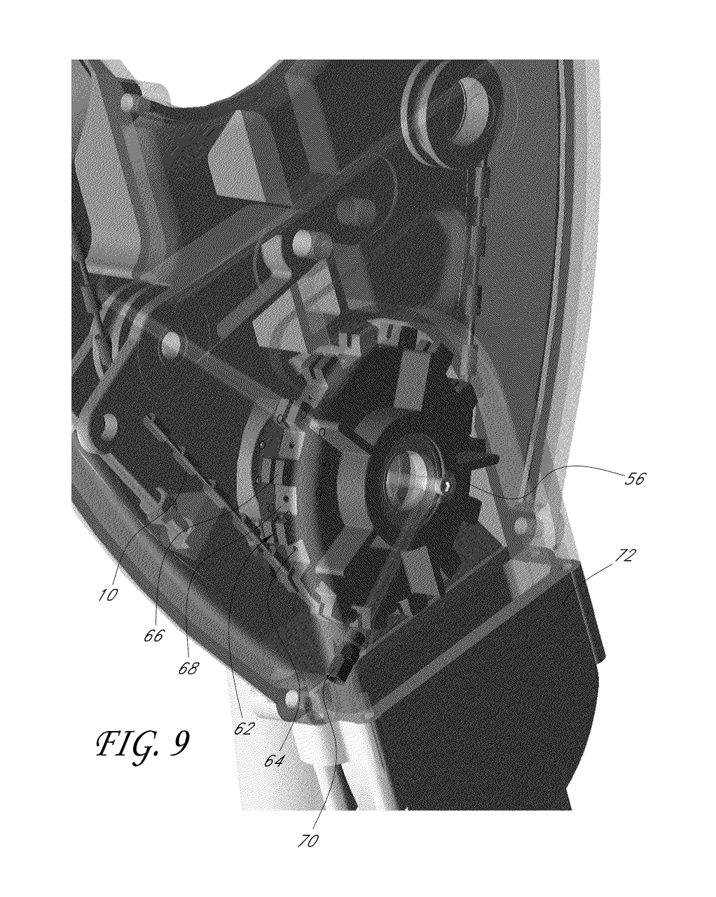

FIGS. 8 and 9 illustrate a cutting tool 50 that can use many of the different embodiments of flexible cutting apparatus 10 disclosed herein. The flexible cutting apparatus 10 can also be used in other types of cutting tools. As shown, the flexible cutting apparatus 10 is enclosed within the cutting tool 50 with the exception of a cutting section 52. In some embodiments, the cutting tool is triangular or “U” shaped. The cutting tool can also be shaped similar to a band saw, chain saw, etc.

The cutting tool 50 can include a motor 54 that can drive a main cog 56. The main cog 56 drives the flexible cutting apparatus 10. In some embodiments, the cutting tool 50 can also comprise at least one of a fluid source 58 and a vacuum source 60. The fluid source 58 can provide fluid for many purposes such as lubrication, cooling, cleaning, and other purposes. Fluid can be directed from the fluid source 58 through one or more fluid channels to parts of the cutting tool 50, flexible cutting apparatus 10 and/or the material being cut. The vacuum source 60 can be used to remove undesired debris or other material through a vacuum conduit 72 and from the cutting tool 50, flexible cutting apparatus 10, and/or the material being cut.

In some embodiments, the cutting tool 50 can be configured to direct fluid from the fluid source at the flexible cutting apparatus 10 to thereby clean off and remove any debris from a cutting action of the flexible cutting apparatus 10. The vacuum source 60 can be positioned and configured to further remove the fluid and the debris from the flexible cutting apparatus 10.

Looking now at FIG. 9, it can be seen that the main cog 56 has a plurality of holes 62, 64. These holes 62, 64 can be used to direct fluid at the flexible cutting apparatus 10 to clean the same and remove debris as discussed above. In some embodiments, the fluid sterilizes the flexible cutting apparatus 10. The holes 62, 64 can be configured to clean different parts of the flexible cutting apparatus 10. For example, the cog can have teeth 66 configured to engage the first link 2 and the space 68 in-between the teeth can be configured to engage the second link 4 and cutter 6. The holes 62, 64 can direct fluid at either or both of the first and second links, whether or not they are engaged with the teeth 66. Advantageously, in embodiments where the cutter 6 can rotate, the cutter 6 can rotate as it is being sprayed by the fluid. This can help clean the cutter 6.

In some embodiments, the fluid comprises at least one of high pressure air, water, saline, and pesticide. In some embodiments, there are one or more different fluids. For example, water can be directed at the flexible cutting apparatus 10 in the main cog 56 and pesticide can be directed into a cut created by the cutting tool 50.

Embodiments consistent with the principles disclosed herein can provide many benefits. In the design of flexible cutting apparatus there is a tradeoff between flexibility and strength. Stronger, stiffer flexible cutting apparatus can be extremely heavy-duty, but less flexible than those designed with the opposite tradeoffs. Flexibility translates into tighter possible turning radiuses around smaller guide and drive wheels, permitting an overall smaller saw.

A flexible cutting apparatus as disclosed herein can have increased strength, more flexibility, and versatility over other designs. For example, a flexible cutting apparatus 10 having first and second links connected with ball and socket joints can have significant increased strength and can be used on a cutting tool with smaller turn radius than similarly sized tools.

In addition, a flexible cutting apparatus 10 as disclosed herein can be quite strong and still provide a high degree of effective flexibility due to a close-fit ball and socket connection. A flexible cutting apparatus 10 as disclosed herein can also provide stiff components but be flexible once assembled.

Other benefits of the flexible cutting apparatus 10 can include less breakage, cleaner cuts, and decreased maintenance costs. The linkages and/or cutters can be individually replaceable. Also as discussed above, flexible cutting apparatus 10 can be self-lubricating and therefore does not require additional lubrication.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the present flexible cutting apparatus and cutting tools have been described in the context of particularly preferred embodiments, the skilled artisan will appreciate, in view of the present disclosure, that certain advantages, features and aspects of the flexible cutting apparatus and cutting tools may be realized in a variety of other applications, many of which have been noted above. Additionally, it is contemplated that various aspects and features of the invention described can be practiced separately, combined together, or substituted for one another, and that a variety of combination and sub-combinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A cutting system comprising:
a plurality of first links, each of the first links comprising:
a first end;
a second end; and
a central portion connecting the first end and the second end;
a plurality of second links, each of the second links comprising:
an external surface; and
an internal surface wherein at least one of the first end and the second end of one of the plurality of first links forms a joint with the internal surface of the second link; and
a plurality of cutting beads, each cutting bead connected to the external surface of one of the plurality of second links;
wherein the cutting system comprises an alternating configuration of one of the plurality of first links and one of the plurality of second links, wherein each of the plurality of second links and the connected cutting beads are configured to freely rotate independent of the position of the other links.

2. The cutting system of claim 1, wherein the first and second ends of each of the plurality of first links comprise ball ends and the joint is a ball and socket joint.

3. The cutting system of claim 1, wherein the central portion of each of the plurality of first links has a smaller outer dimension than the first and second ends.

4. The cutting system of claim 1, wherein the first and second ends of each of the plurality of first links around at least one of round, semispherical, spherical, elliptical, oval, conical, triangular or pyramidal, and spherical with a flat end.

5. The cutting system of claim 1, further comprising lubricant, wherein the links are self-lubricating and the lubricant is sealed inside each of the plurality of second links.

6. The cutting system of claim 1, wherein each cutting bead comprises a plurality of teeth.

7. The cutting system of claim 1, wherein the plurality of teeth are configured and shaped to rotate the cutting bead about an axis while cutting.

8. The cutting system of claim 1, wherein each cutting bead comprises a sleeve that fits over one end of the second link.

9. The cutting system of claim 8, wherein the external surface of the second link comprises a flange, wherein an end of the cutting bead abuts the flange.

10. The cutting system of claim 1, wherein each of the plurality of second links comprises two portions that define the external surface and the internal surface

11. The cutting system of claim 1, wherein the alternating configuration forms a loop.

12. A cutting system comprising:
a plurality of first links, each first link having ball ends and a shaft connecting the ball ends;
a plurality of second links, each second link having a first end inside surface configured to form a ball and socket joint with one of the ball ends of one of the plurality of first links and a second end inside surface configured to form a ball and socket joint with one of the ball ends of another one of the plurality of first links; and
a plurality of cutting beads, each cutting bead configured to connect to an outside surface of one of the plurality of second links.

13. The cutting system of claim 12, wherein each of the plurality of second links comprises first and second portions that when connected form a chamber inside the second link and define the inside surfaces of the first end and the second end.

14. The cutting system of claim 13, wherein the first and second portions comprise first and second halves of the second link with an interlocking feature.

15. The cutting system of claim 12, wherein each of the plurality of second links further comprises a restraining feature to prevent separation of the cutting bead from the outside surface of the second link.

16. The cutting system of claim 15, wherein the restraining feature comprises a flange and an end of the cutting bead configured to abut the flange.

17. The cutting system of claim 12, wherein each cutting bead comprises a sleeve that configured to fit over an external end of the second link.

18. The cutting system of claim 13, further comprising lubricant within the chamber in each of the plurality of second links, wherein when in use the internal chamber of each of the plurality second links is substantially sealed.

19. The cutting system of claim 12, further comprising:
a fluid channel; and
a vacuum conduit;
wherein the cutting system is configured to direct fluid through the fluid channel at the plurality of first and second links and cutting beads, to thereby clean off and remove debris from a cutting action of the plurality of cutting beads and the vacuum conduit is positioned and configured to remove the fluid and the debris.

20. The cutting system of claim 19 further comprising a cog for engaging the plurality of first and second links and cutting beads, wherein the cog comprises internal piping to direct the fluid at areas of the plurality of first and second links and cutting beads engaged with the cog.

21. The cutting system of claim 20, wherein the cog comprises a plurality of holes.

22. The cutting system of claim 21, wherein the cog further comprises a plurality of teeth configured to engage the plurality of first links and having regions between adjacent teeth configured to engage the plurality of cutting beads, wherein the plurality of holes are both in the teeth and in the regions between the adjacent teeth.

23. The cutting system of claim 19, wherein the fluid comprises at least one of high pressure air, water, saline, and pesticide.

24. The cutting system of claim 19, further comprising a second fluid channel, wherein the second fluid channel is positioned to direct a second fluid into a cut created by the cutting system.

25. The cutting system of claim 24, wherein the second fluid is a high pressure spray comprising pesticide.

26. The cutting system of claim 24, wherein the second fluid is the same as the first fluid.

27. A cutting device comprising:
a plurality of main bodies linkedly connected in series along an axis; and
a plurality of generally cylindrical cutting surfaces, the cutting surface configured to surround a portion of one of the plurality of main bodies;
wherein the cutting device is configured to support a tension along a length of the cutting device;
wherein the plurality of cutting surfaces are configured to independently rotate about their respective axes.
